(19) United States
(12) Patent Application Publication
(10) Pub. No.: US 2004/0225403 A1
(43) Pub. Date: Nov. 11, 2004

(54) Method of duplicating future actions of the wafer batch in a semiconductor process

(76) Inventor: Pei-Ting Chu, Hsin-Chu (TW)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/834,174

(22) Filed: Apr. 29, 2004

(30) Foreign Application Priority Data
May 8, 2003 (TW) 92112616

(51) Int. Cl. G06F 19/00

(52) U.S. Cl. 700/121

(57) ABSTRACT

A method of duplicating future actions of the wafer batch in a semiconductor process is described. A procedure stack is first presented by a hierarchy structure of a source procedure. The procedure stack is then encoded to form one-to-one mapping codes to match the hierarchy structure. Afterwards, the mapping codes are copied from the source procedure to a target procedure and the hierarchy structure of the target procedure is the same as that of the source procedure. Finally, the mapping codes of the target procedure are decoded to the procedure stack of the target procedure. As a result, the procedure stack of the source procedure is the same as that of the target procedure.

### BACKGROUND OF THE INVENTION

1. Field of Invention

The invention relates to a method of semiconductor process and, in particular, to a method of duplicating future actions of the wafer batch in a semiconductor process.

2. Related Art

In the development from semiconductor processes to very large scale integration (VLSI), the manufacturing process becomes increasingly complicated and difficult. For a highly integrated circuit (IC), it often involves hundreds of steps. In particular, a same set of the wafer batch contains tens of different manufacturing stations. Alternatively, different sets of the wafer batches may repeatedly go through similar steps. That is, these different wafer batches are similar products. When the future action of the wafer batch is copied to another wafer batch, the convoluted process also increases the complexity of future action duplication.

Basically, before performing the semiconductor procedure, the operator usually has to set the future action of future hold in order for the engineer to check the conditions of wafers during the hold. Generally speaking, the engineer has to set multiple future holds for each of the procedure. For example, suppose the user sets future holds for a procedure of the wafer batch. If there are 10 batches involved in this procedure, the user has to set 100 future holds. Therefore, it is very time-consuming and likely to make mistakes. In particular, if future holds are not correctly set in the procedure, defects produced during the procedure cannot be discovered in time, resulting in wastes.

Therefore, how to improve the duplication method of future action of the wafer batch in a semiconductor process is an important issue in the field.

### SUMMARY OF THE INVENTION

An objective of the invention is to provide a method of duplicating future actions of the wafer batch in a semiconductor process. A better duplication mechanism is employed to save the user's setting time.

Another objective of the invention is to use an accurate duplication method to avoid setting incorrect future actions during the procedure that may result in wrong operations.

According to the above objectives, the invention provides a method of duplicating future actions of the wafer batch in a semiconductor process. A procedure stack is first presented by a hierarchy structure of a source procedure. The procedure stack is then encoded to form one-to-one mapping codes to match the hierarchy structure. Afterwards, the mapping codes are copied from the source procedure to a target procedure. In a preferred embodiment of the invention, the hierarchy structure of the target procedure is the same as that of the source procedure. Finally, the mapping codes of the target procedure are decoded to the procedure stack of the target procedure. As a result, the procedure stack of the source procedure is the same as that of the target procedure.

Although the identifications of the source procedure and target procedure are similar to the operator, they are apparently different for the information manager. Therefore, the information manager cannot find the correspondence relations among the stack information according to the identifications before encoding.

In order for the operator to clearly understand the coding information for the convenience of setting future action values, the invention encodes the stack information of the source procedure. The operator can read out the relations among the main procedure and auxiliary procedure directly from the identifications (i.e. the auxiliary procedure has a source from the main procedure). More importantly, after the encoded stack information is copied to the target procedure, the identifications of the main and auxiliary procedure are converted into those of the target procedure, forming one-to-one mapping codes. This helps accurately duplicating the future action of the source procedure.

In summary, the disclosed method of duplicating future actions of the wafer batch in a semiconductor procedure utilizes a preferred duplication mechanism in the procedure of the wafer batch in order to rapidly copying the stack information of the procedure. It saves the operation time and accurately copies the stack information. The invention prevents incorrect future action settings in the procedure of the wafer batch, avoiding users from incorrect operations.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a schematic view of the hierarchy in the source procedure of the wafer batch in a semiconductor process according to the invention;

FIG. 2 is a schematic view of the hierarchy in the target procedure of the wafer batch in a semiconductor process according to the invention; and

FIG. 3 is a flowchart of the disclosed method of duplicating future actions of the wafer batch in a semiconductor process.

### DETAILED DESCRIPTION OF THE PREFERRED EMBODIMENT

In view of the drawbacks in the conventional future action of the wafer batch in a semiconductor process, the invention provide a method of duplicating future actions of the wafer batch in a semiconductor process that utilizes a better duplication mechanism during the wafer batch procedure to rapidly copying stack information. It saves the operator's time and accurately copies the stack information, preventing incorrect future action of the wafer batch from resulting in wrong actions. The disclosed method applies to the Promis information management system.

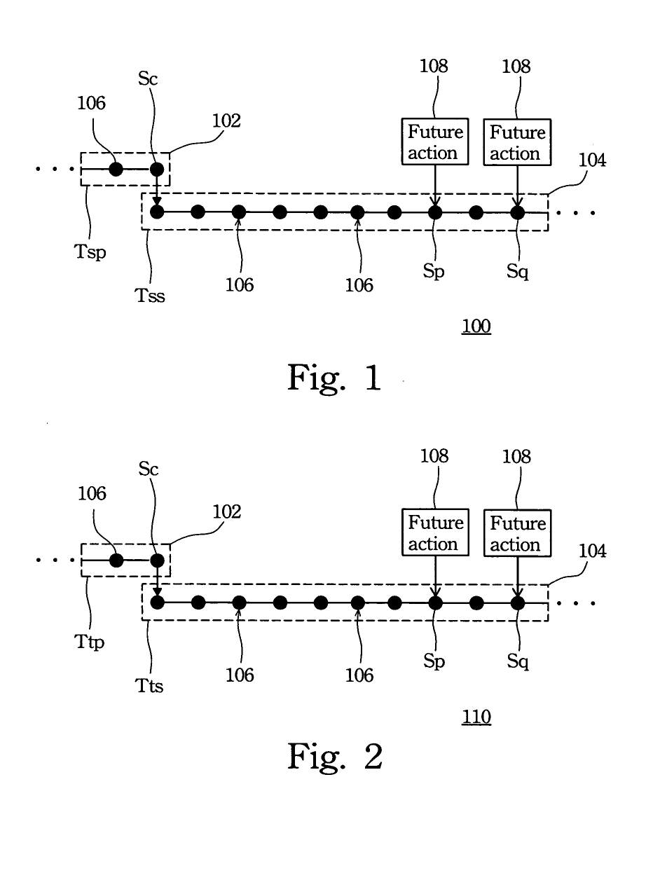

With reference to FIG. 1, the source procedure 100 contains a main procedure 102 and an auxiliary procedure 104. The main procedure 102 and the auxiliary procedure 104 are given an identification (ID) Tsp and Tss, respectively. The main procedure 102 and the auxiliary procedure 104 are comprised of several steps 106, part of which contains future actions 108.

Basically, the main procedure 102 calls the auxiliary procedure 104 at the switching step Sc, forming a hierarchy structure. For example, the auxiliary procedure 104 has future actions 108 in the Sp and Sq steps 106. In the preferred embodiment of the invention, the future action 108 is a future hold so that the wafer batch stops accordingly in the procedure for the engineer or the automatic testing device to check whether there is any defect. In another embodiment, the future action is a future rework used to correct the defects in the wafer batch. Thus, defects can be avoided or amended in specific steps of the procedure to save the production costs. Moreover, the future action 108 can be a future split that picks out defective wafers in the batch so that all final wafer batches are good, resulting in a higher yield. Furthermore, the future action can be a future new part, future procedure change, future parameter update, future parameter delete, and future merge.

During the operation, the wafer batch moves in order in the main procedure 102 and the auxiliary procedure 104. The steps 106 are performed according to the selected future actions 108. Such steps 106 include semiconductor process steps, measuring steps, or dummy steps. Each of the steps 106 can involve a machine. More explicitly, the main procedure 102 and the auxiliary procedure 104 are comprised of many steps 106. The engineer uses an information management system to set future actions 108 in some of the steps so that these future actions 108 are performed to complete integrated circuit (IC) tests.

In the preferred embodiment of the invention, the main procedure 102 calls one or several auxiliary procedures 104 to go through complicated steps for a wafer batch. This method helps increasing the flexibility of the procedures. That is, each source procedure 100 is given with different main procedure 102 and auxiliary procedure 104. The wafer batch is manufactured according to the future action settings 108 in the procedures.

Similar to the source procedure 100 of FIG. 1, the target procedure 110 in FIG. 2 also contains a main procedure 102 and an auxiliary procedure 104. The main procedure 102 and the auxiliary procedure 104 are given an identification (ID) Ttp and Tts, respectively. The main procedure 102 and the auxiliary procedure 104 are comprised of several steps 106, part of which contains future actions 108. Basically, the main procedure 102 calls the auxiliary procedure 104 at the switching step Sc, forming a hierarchy structure.

A primary objective of the invention is to utilize a duplication mechanism to copy the procedure stack of future action 108 in the source procedure 100 to the target procedure 110 according to the user's needs. In the following, we explain the disclosed duplication method.

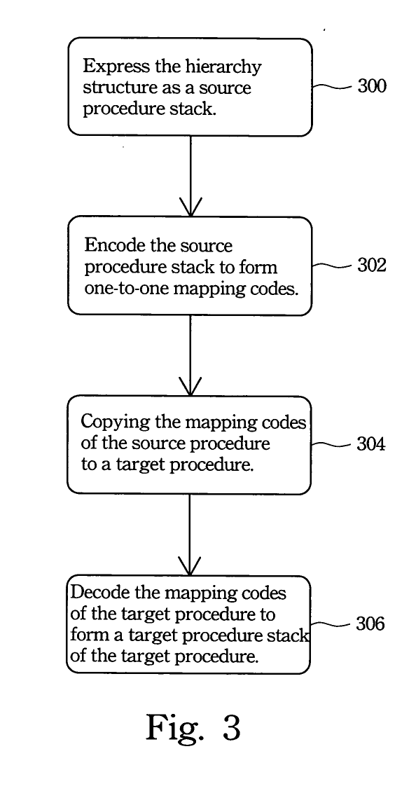

As shown in FIG. 3, the hierarchy structure of the source procedure 100 is turned into a procedure stack, described by

Tsp: Sc - - - (1)

Tss: Sp - - - (2a)

Tsp: Sc - - - (1)

Tss: Sq - - - (2b)

Afterwards, the hierarchy structure of the target procedure 110 is also expressed as a procedure stack:

Ttp: Sc - - - (3)

Tts: Sp - - - (4a)

Ttp: Sc - - - (3)

Tts: Sq - - - (4b)

The above mentioned procedure stack refers to the data structure formed after expanding according to the hierarchy. Explicitly speaking, the function of the procedure stack in the source procedure 100 and the target procedure 110 is to describe the position of the wafer batch in the whole procedure.

For example, in the source procedure 100, there is a future hold in each of the Sp and Sq steps in the auxiliary procedure 104 with the ID Tsp of the main procedure 102. The future hold is the future action 108 to be performed in steps Sp and Sq on the wafer batch set by the user. The procedure stack is used to show the hierarchy depth of the wafer batch in the procedure. That is, it shows the hierarchy rank of the main procedure 102 and auxiliary procedure 104 in the source procedure 100 or the target procedure 110.

In step 302, the stack of source procedure 100 is encoded. That is, the source procedure stack description (1), (2a), and (2b) are encoded to form one-to-one mapping codes corresponding to the hierarchy structure of the procedure. To be more specific, the Tsp is encoded as A and Tss as AA. The stack information of the encoded source procedure 100 is

A:Sc, AA:Sp; A:Sc, AA:Sq.

In step 304, the mapping codes of the source procedure 100 are copied to the target procedure 110. According to the preferred embodiment of the invention, the hierarchy structure of the target procedure 110 is the same as that of the source procedure 100. Before copying the procedure stack, the future action in the target procedure 110 and that of the source procedure 100 can be the same or different. After duplication, the future action in the target procedure 110 and that of the source procedure 100 become the same. When the hierarchy structure of the target procedure 110 is similar to that of the source procedure 100, the target procedure stack and the source procedure stack have some different future actions 108. Since the invention uses the duplication mechanism of the information management system to copy the encoded source procedure stack information A:Sc, AA:Sp; A:Sc, AA:Sq to the target procedure 110.

Finally, in step 306, the mapping codes of the target procedure 110 is decoded to form the procedure stack in the target procedure 110. Thus, the target procedure stack is the same as the source procedure stack, as described in the following:

A:Sc, AA:Sp is decoded as:

Ttp: Sc - - - (3)

Tts: Sp - - - (4a)

At the same time, A:Sc, AA:Sq is decoded as:

Ttp: Sc - - - (3)

Tts: Sq - - - (4b)

Even the name's of the source procedure 100 and the target procedure 110 are the same to the operator (i.e. Tsp and Ttp are different in version and so are Tss and Tts), they are different for the information manager. Therefore, before encoding, the information manager cannot know the mapping relations of the stack information from the ID's.

In order for the operator to clearly understand the encoded information and to facilitate the setting of future actions 108, the invention encodes the stack information of the source procedure 100 into A and AA. The operator can readily read out the relation between the main procedure 102 and the auxiliary procedure 104, e.g. the auxiliary procedure AA is derived from the main procedure A. More importantly, after the encoded stack information is copied to the target procedure 110, the ID's of the main procedure 102 and the auxiliary procedure 104 are converted into those of the ID's in the target procedure 110. That is Tsp is converted to Ttp and Tss to Tts, forming one-to-one mappings. This helps accurately copying the future actions 108 of the source procedure 100.

In the information management system, if the ID's of the procedures change, the stack information of the source procedure 100 cannot be copied to the target procedure 110. The one-to-one mapping method disclosed here can accurately copy the stack information of the source procedure 100, avoiding the situation of incorrect future action settings.

In the preferred embodiment, the duplication of procedure stack information can be performed according to the ID of the main procedure 102, without the need to expand the auxiliary procedure 104. Therefore, the steps of stack information duplication are simplified. For example, one can use the procedure ID's of an existing product to copy stack information to the procedures of another similar product. In other words, the invention is most suitable for products with similar specifications because they involve same future actions 108. Using the duplication mechanism of the invention, the same future actions 108 can be copied to the procedure for another similar product.

In summary, the invention uses a method of duplicating future actions of the wafer batch in a semiconductor process. A preferred duplication mechanism is used in the manufacturing process of the wafer batch to rapidly duplicating the stack information of the manufacturing procedure to save the operator's time and to accurately duplicate the stack information. Therefore, the wafer batch will not have incorrect future actions in the procedure, in order to avoid wrong operations by the user.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of duplicating future actions of the wafer batch in a semiconductor process, the wafer batch being produced according to a source procedure with a hierarchy structure, which method comprises the steps of:
expressing the hierarchy structure as a source procedure stack;
encoding the source procedure stack to form one-to-one mapping codes corresponding to the hierarchy structure;
copying the mapping codes of the source procedure to a target procedure; and
decoding the mapping codes of the target procedure to form a target procedure stack of the target procedure for manufacturing the wafer batch according to the future actions in the target procedure.

2. The method of claim 1, wherein the future actions are used in an information management system.

3. The method of claim 1, wherein the source procedure is used in a Promis information management system.

4. The method of claim 1, wherein the target procedure is used in a Promis information management system.

5. The method of claim 1, wherein the future actions are selected from the group consisting of a future hold, a future change, a future split, a future new part, a future procedure change, a future parameter update, a future parameter delete, a future merge, and their combinations.

6. The method of claim 1, wherein the hierarchy structure of the target procedure is the same as that of the source procedure.

7. The method of claim 6, wherein the target procedure stack and the source procedure stack have the same future actions.

8. The method of claim 1, wherein the hierarchy structure of the target procedure is similar to that of the source procedure.

9. The method of claim 8, wherein the target procedure stack and the source procedure stack have different future actions.

10. A method of duplicating future actions of the wafer batch in a semiconductor process, the wafer batch being produced according to a source procedure with a hierarchy structure, wherein the wafer batch setting comprises the steps of:
expressing the hierarchy structure as a source procedure stack;
encoding the source procedure stack to form one-to-one mapping codes corresponding to the hierarchy structure;
copying the mapping codes of the source procedure to a target procedure with the hierarchy structure of the target procedure the same as that of the source procedure; and
decoding the mapping codes of the target procedure to form a target procedure stack of the target procedure for manufacturing the wafer batch according to the future actions in the target procedure.

11. The method of claim 10, wherein the future actions are used in an information management system.

12. The method of claim 10, wherein the source procedure is used in a Promis information management system.

13. The method of claim 10, wherein the target procedure is used in a Promis information management system.

14. The method of claim 10, wherein the future actions are selected from the group consisting of a future hold, a future change, a future split, a future new part, a future procedure change, a future parameter update, a future parameter delete, a future merge, and their combinations.

15. The method of claim 10, wherein the hierarchy structure of the target procedure is the same as that of the source procedure.

16. The method of claim 15, wherein the target procedure stack and the source procedure stack have the same future actions.

17. The method of claim 10, wherein the hierarchy structure of the target procedure is similar to that of the source procedure.

18. The method of claim 17, wherein the target procedure stack and the source procedure stack have different future actions.

19. A method of duplicating future actions of a batch, the batch being produced according to a source procedure with a hierarchy structure, wherein the method comprises the steps of:
expressing the hierarchy structure as a source procedure stack;
encoding the source procedure stack to form one-to-one mapping codes corresponding to the hierarchy structure;
copying the mapping codes of the source procedure to a target procedure with the hierarchy structure of the target procedure the same as that of the source procedure; and
decoding the mapping codes of the target procedure to form a target procedure stack of the target procedure for manufacturing the wafer batch according to the future actions in the target procedure.

20. The method of claim 19, wherein the future actions are used in an information management system.

21. The method of claim 19, wherein the source procedure is used in a Promis information management system.

22. The method of claim 19, wherein the target procedure is used in a Promis information management system.

23. The method of claim 19, wherein the future actions are selected from the group consisting of a future hold, a future change, a future split, a future new part, a future procedure change, a future parameter update, a future parameter delete, a future merge, and their combinations.

24. The method of claim 19, wherein the hierarchy structure of the target procedure is the same as that of the source procedure.

25. The method of claim 24, wherein the target procedure stack and the source procedure stack have the same future actions.

26. The method of claim 19, wherein the hierarchy structure of the target procedure is similar to that of the source procedure.

27. The method of claim 26, wherein the target procedure stack and the source procedure stack have different future actions.
